(19) United States
(12) Patent Application Publication
(10) Pub. No.: US 2011/0292103 A1
(43) Pub. Date: Dec. 1, 2011

(54) IMAGE FORMING APPARATUS AND METHOD OF INKJET HAVING HUMIDITY ADJUSTMENT MECHANISM

(75) Inventors: Takashi Hatakeyama, Kanagawa-ken (JP); Atsushi Kubota, Shizuoka-ken (JP); Nobuaki Takahashi, Shizuoka-ken (JP)

(73) Assignees: TOSHIBA TEC KABUSHIKI KAISHA, Tokyo (JP); KABUSHIKI KAISHA TOSHIBA, Minato-ku (JP)

(21) Appl. No.: 13/118,832

(22) Filed: May 31, 2011

Related U.S. Application Data
(60) Provisional application No. 61/350,281, filed on Jun. 1, 2010.

(51) Int. Cl. B41J 29/38

(52) U.S. Cl. 347/6

(57) ABSTRACT

According to one embodiment, an inkjet image forming apparatus includes an inkjet head configured to discharge water-based ink and form an image on a surface of a recording medium, a medium conveyance part configured to convey the recording medium, a solution imparting part that is disposed upstream of the inkjet head in a recording medium conveyance direction and uses another inkjet head to impart a solution to the surface of the recording medium on which the image is formed, and a controller configured to calculate an imparting amount of the solution to be imparted to the recording medium and control an imparting operation to the recording medium.

### CROSS-REFERENCE TO RELATED APPLICATIONS

This application is based upon and claims the benefit of U.S. Provisional Application No. 61/350,281, filed on Jun. 1, 2010; the entire contents of which are incorporated herein by reference.

### FIELD

Embodiments described herein relate generally to an inkjet image forming apparatus including a mechanism to humidify a medium, and an image forming method.

### BACKGROUND

Hitherto, when an image is formed by using water-based ink, there is a problem that paper deformation (cockling and curl) due to moisture in ink occurs. When the paper in which the cockling occurs is conveyed, the paper collides against parts, such as a print head, in a printing apparatus, and a paper jam can occur. Besides, after the paper in which the cockling occurs comes out from the apparatus, since the cockling is not eliminated, when the paper is stacked, the thickness increases and the handling becomes difficult.

In related art, there is known a technique of avoiding a collision between a paper in which cockling occurs and parts. This technique specifies the handling of the paper after the deformation is caused by printing. Accordingly, there is a need to reduce the deformation caused in a paper by printing.

### BRIEF DESCRIPTION OF THE DRAWINGS

FIG. 1 is a view showing an exemplary schematic structure of an inkjet image forming apparatus of an embodiment.

FIG. 2 is a view showing an exemplary structure of a control system of the inkjet image forming apparatus of the embodiment.

FIG. 3 is an exemplary flowchart showing an image forming operation procedure of the inkjet image forming apparatus of the embodiment.

FIG. 4 is an exemplary flowchart showing a moisture imparting amount determination process procedure according to the embodiment.

FIG. 5 is an exemplary flowchart showing a moisture imparting amount determination process procedure based on image density according to the embodiment.

FIG. 6 is an exemplary view for explaining an effect of reduction of cockling when moisture is imparted in the inkjet image forming apparatus of the embodiment.

FIG. 7 is an exemplary view for explaining an effect of reduction of curl when moisture is imparted in the inkjet image forming apparatus of the embodiment.

FIG. 8 is an exemplary view showing the direction of a fiber when a medium used in the inkjet image forming apparatus of the embodiment is a paper.

FIG. 9A is an exemplary view showing a first mode of imparting a solution in the image forming apparatus of the embodiment.

FIG. 9B is an exemplary view showing the first mode of imparting the solution in the image forming apparatus of the embodiment.

FIG. 9C is an exemplary view showing the first mode of imparting the solution in the image forming apparatus of the embodiment.

FIG. 10A is an exemplary view showing a second mode of imparting a solution in the image forming apparatus of the embodiment.

FIG. 10B is an exemplary view showing the second mode of imparting the solution in the image forming apparatus of the embodiment.

FIG. 11A is an exemplary view showing a third mode of imparting a solution in the image forming apparatus of the embodiment.

FIG. 11B is an exemplary view showing the third mode of imparting the solution in the image forming apparatus of the embodiment.

### DETAILED DESCRIPTION

In general, according to one embodiment, an inkjet image forming apparatus includes an inkjet head configured to discharge water-based ink and form an image on a surface of a recording medium; a medium conveyance part configured to convey the recording medium; a solution imparting part that is disposed upstream of the inkjet head in a recording medium conveyance direction and uses another inkjet head to impart a solution to the surface of the recording medium on which the image is formed; and a controller configured to calculate an imparting amount of the solution to be imparted to the recording medium and control an imparting operation to the recording medium.

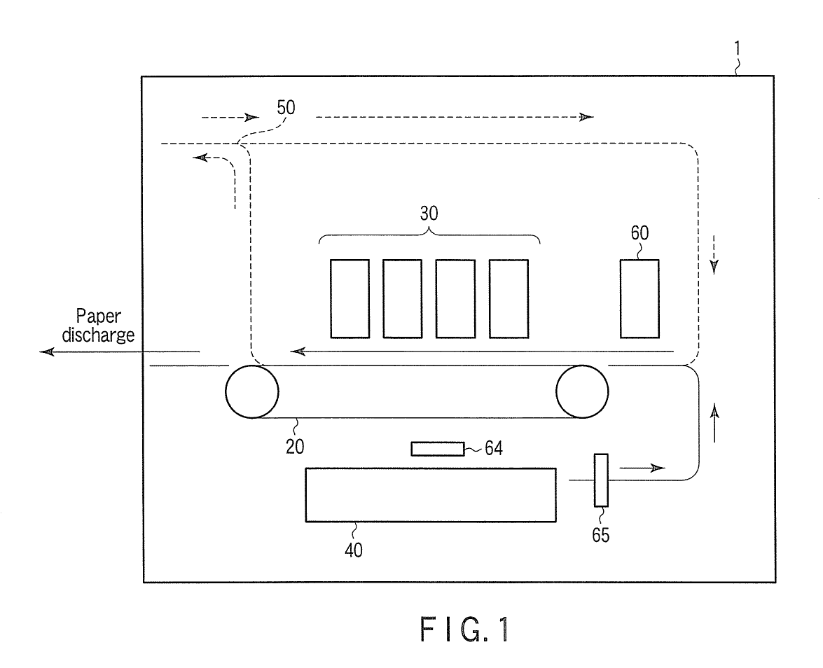

FIG. 1 is a view showing an exemplary schematic structure of an inkjet image forming apparatus of an embodiment.

The inkjet image forming apparatus 1 includes a medium conveyance part 20, an inkjet head mount part 30, a medium holding part 40, a medium reversing part 50, a moisture imparting part 60, a temperature and humidity detection sensor 64, and a paper thickness detection sensor 65.

The medium conveyance part 20 conveys a medium. The inkjet head mount part 30 forms an image on the medium. The medium holding part 40 holds a medium, such as a paper, on which an image is formed. The medium reversing part 50 reverses the medium. The moisture imparting part 60 uses an inkjet head mechanism to impart moisture to the surface of the medium to be printed. An imparting method of moisture will be described later. The temperature and humidity detection sensor 64 detects the temperature and humidity in the medium holding part 40. The paper thickness detection sensor 65 detects the thickness of the medium taken out from the medium holding part 40 in order to form an image.

As a solution to be imparted to a medium, a liquid in which viscosity or the like is adjusted, water or a processing liquid for improving picture quality and resistance to water can be used. For example, the processing liquid includes water of 30 to 80 weight % and an additive such as a wetting agent for improving wettability or a surfactant. Besides, the solution imparted once per A4 (standard paper 5 g/A4) is set to be 0.05 g to 0.4 g (1 to 8%).

A schematic operation of the inkjet image forming apparatus 1 will be described. The inkjet image forming apparatus 1 has, as printing modes, a one-sided printing mode and a two-sided printing mode.

In the case of the one-sided printing mode, the moisture imparting part 60 imparts a solution to a surface to be printed of a medium taken out from the medium holding part 40, and the medium conveyance part 20 conveys the medium. During conveyance, the ink-jet mount part 30 forms an image on the medium, and the medium is discharged to the outside of the apparatus.

In the case of the two-sided printing mode, the medium is further conveyed in the image forming apparatus. The medium reversing part 50 reverses the medium, and again supplies the medium to the moisture imparting part 60. The moisture imparting part 60 imparts the solution to the surface to be printed of the reversed medium. The reversed medium is conveyed by the medium conveyance part 20, and after an image is formed by the inkjet head mount part 30, the medium is discharged to the outside of the image forming apparatus.

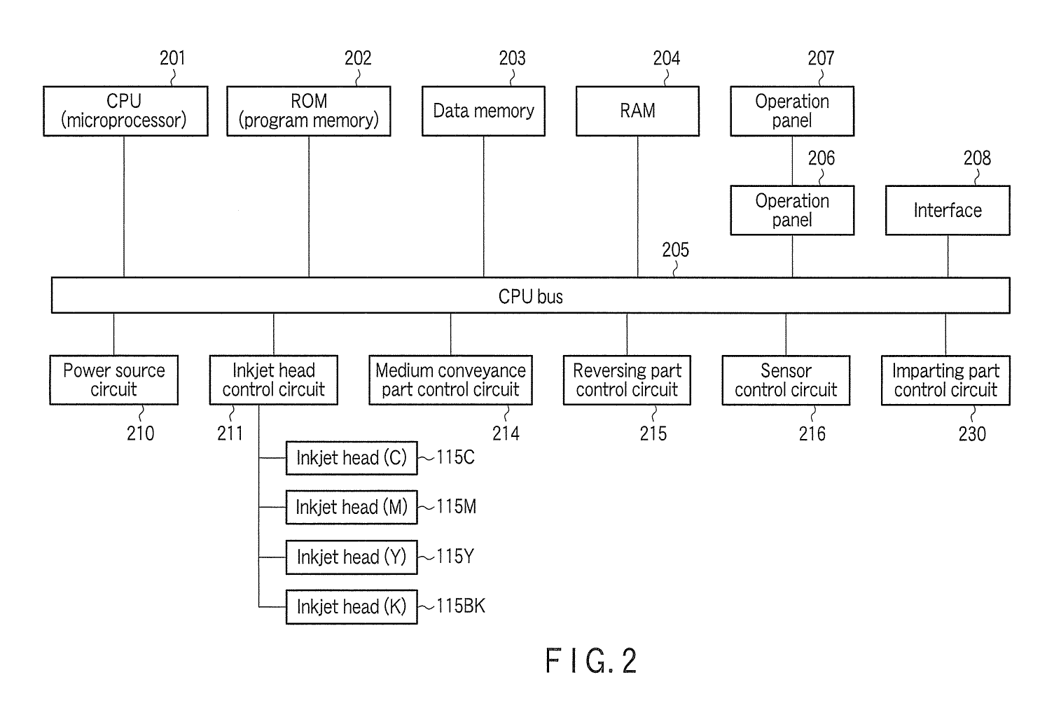

FIG. 2 is a view showing an exemplary structure of a control system of the inkjet image forming apparatus 1 of the embodiment.

The control system of the inkjet image forming apparatus 1 includes a CPU (microprocessor) 201, a ROM (program memory) 202, a data memory 203, a RAM (working memory) 204, a CPU bus 205, an input port 206, an interface 208, a power source circuit 210, an inkjet head control circuit 211, a medium conveyance part control circuit 214, a reversing part control circuit 215, a sensor control circuit 216 and an imparting part control circuit 230.

The CPU (microprocessor) 201 overall controls the respective components of the inkjet image forming apparatus 1. The ROM (program memory) 202 and the RAM (working memory) 204 are connected to the CPU 201 through the CPU bus 205, and constitute a microcomputer. The ROM 202 or the data memory 203 stores an operation program to execute drive control. The input port 206 transmits and receives information to and from an operation panel 207. The interface 208 transmits and receives information to and from an external computer.

The inkjet head control circuit 211 drives and operates respective inkjet heads 115. The medium conveyance part control circuit 214 drives respective conveyance units such as various rollers. The reversing part control circuit 215 controls the operation of the medium reversing part 50. The sensor control circuit 216 controls the detection operation of the temperature and humidity detection sensor 64 and the paper thickness detection sensor 65. The imparting part control circuit 230 controls the operation of the moisture imparting part 60. The power source circuit 210 supplies power source voltages to the respective components of the inkjet image forming apparatus 1. Besides, the power source circuit 210 outputs control voltages of the respective inkjet heads 115 and motor control voltage for drive control of the medium conveyance part 20.

Next, the control operation of the inkjet image forming apparatus 1 will be described. The respective components of the inkjet image forming apparatus 1 are basically controlled by the CPU 201. The respective components are controlled based on the program stored in the ROM 202 or the data memory 203. First, image data or a print command sent from the external computer through the interface 208 is transferred to the RAM (working memory) 204, and is processed by the CPU 201 based on the operation program stored in the ROM (program memory) 202 and the instruction data stored in the data memory 203.

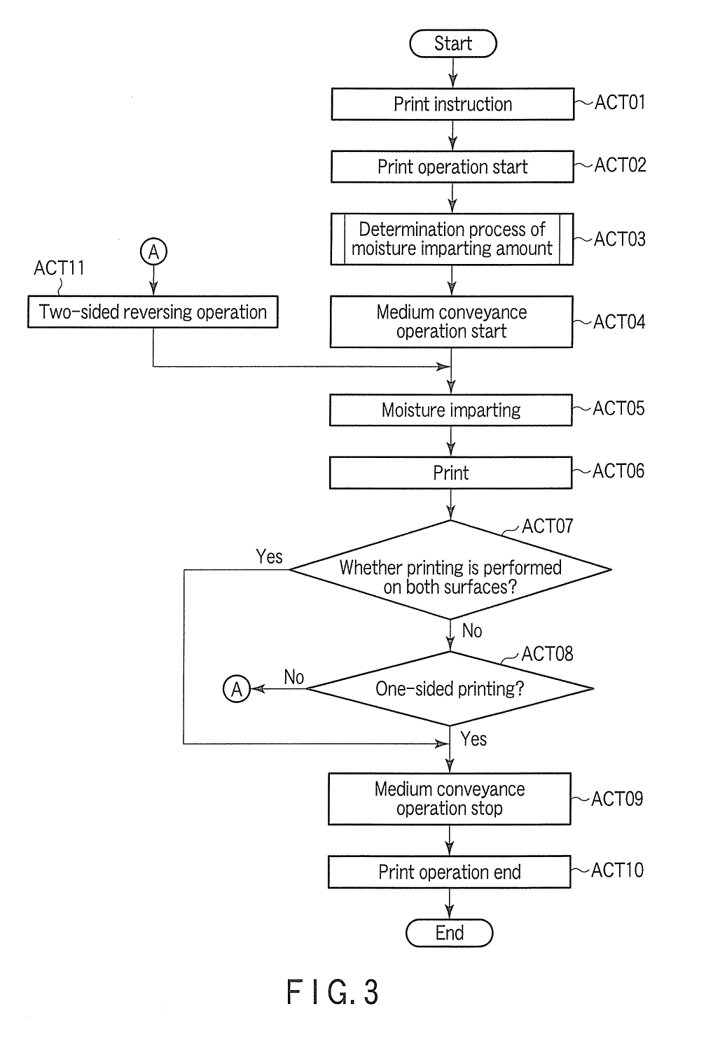

FIG. 3 is an exemplary flowchart showing an image forming operation procedure of the inkjet image forming apparatus 1 of the embodiment.

At ACT 01, the user gives a print instruction. At ACT 02, the CPU 201 instructs the respective component of the inkjet image forming apparatus 1 to start a printing operation. At ACT 03, the CPU 201 executes a determination process of a moisture imparting amount.

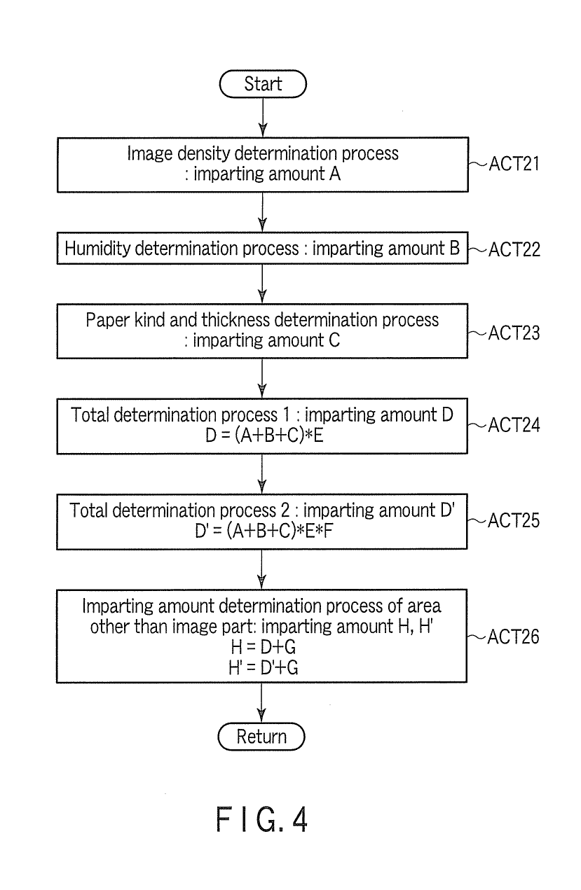

FIG. 4 is an exemplary flowchart showing a determination process procedure of the moisture imparting amount according to the embodiment.

At ACT 21, the CPU 201 acquires density data of an image to be printed, and determines the moisture imparting amount based on the density of the image. Incidentally, the moisture imparting amount described below is the moisture amount per unit area of the medium.

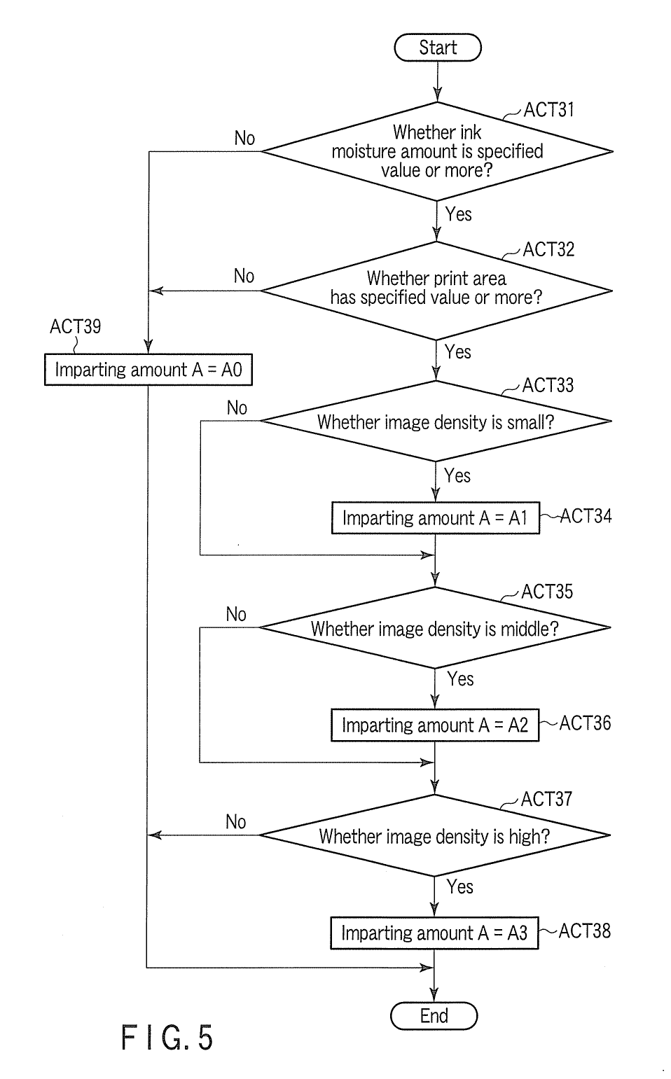

FIG. 5 is an exemplary flowchart showing the determination process procedure of the moisture imparting amount based on the density of the image according to the embodiment.

At ACT 31, it is determined whether the moisture amount of ink to be used is a specified value or more. The moisture amount of the ink to be used is determined by the kind of the ink to be used. Accordingly, the user may input the kind of the ink to be used through the operation panel 207, or a sensor may read information indicating the kind from an ink cartridge. When the ink moisture amount is smaller than the specified value (ACT 31 NO), at ACT 39, the moisture imparting amount A is made A0. Then, return is made to FIG. 4.

When the ink moisture amount is the specified value or more (ACT 31 YES), at ACT 32, it is determined whether an area to be printed on the medium is a specified value or more. The print area is obtained from the print data. When the print area is smaller than the specified value (ACT 32 NO), at ACT 39, the moisture imparting amount A is made A0. Then, return is made to FIG. 4.

When the print area is the specified value or more (ACT 32 YES), at ACT 33, it is determined whether image density is small. That is, it is checked whether the ratio (print ratio) of the print area to the whole sheet is a threshold TH1 or less. When the print ratio is the threshold TH1 or less (ACT 33 YES), at ACT 34, the moisture imparting amount A is made A1. Then, ACT 35 is executed.

When the print ratio is higher than the threshold TH1 (ACT 33 NO), at ACT 35, it is determined whether the image density is middle. That is, it is checked whether the print ratio is higher than the threshold TH1 and a threshold TH2 or less. In the case of TH1<print ratio≦TH2 (ACT 35 YES), at ACT 36, the moisture imparting amount A is made A2. Then, ACT 37 is executed.

At ACT 37, it is determined whether the image density is high. That is, it is checked whether the print ratio is higher than the threshold TH2. In the case of TH2<print ratio (ACT 37 YES), at ACT 38, the moisture imparting amount A is made A3. Then, return is made to FIG. 4.

The moisture imparting amount A based on the image density is determined by the above procedure. Incidentally, A0<A1<A2<A3 and TH1<TH2 are established. That is, as the print ratio becomes high, the moisture imparting amount increases.

At ACT 22 of FIG. 4, the CPU 201 acquires the humidity of the medium holding part 40 detected by the temperature and humidity detection sensor 64. The CPU 201 determines a moisture imparting amount B from the acquired humidity.

The procedure of obtaining the moisture imparting amount B is the same as the determination process procedure of the moisture imparting amount based on the density of the image shown in FIG. 5. That is, the moisture imparting amount B is obtained based on the ink moisture amount, the area of a print area, and the range of a humidity value. As the humidity value becomes large, the imparting moisture amount increases. Accordingly, the explanation of the detailed process procedure of obtaining the moisture imparting amount B is omitted.

At ACT 23, the CPU 201 picks up a medium from the medium holding part 40, and acquires the thickness of the picked-up medium detected by the paper thickness detection sensor 65. Alternatively, the CPU 201 acquires the thickness of the medium from the kind (basis weight) of the medium inputted by the user through the operation panel 207. The CPU 201 determines a moisture imparting amount C corresponding to the acquired thickness of the medium.

The procedure of obtaining the moisture imparting amount C is the same as the determination process procedure of the moisture imparting amount based on the density of the image shown in FIG. 5. That is, the moisture imparting amount C is obtained based on the ink moisture amount, the area of a print area, and the range of thickness of the medium. As the thickness of the medium increases, the moisture imparting amount decreases. Accordingly, the explanation of the detailed process procedure of obtaining the moisture imparting amount C is omitted.

At ACT 24, the CPU 201 obtains a moisture imparting amount D by a total determination process 1. The moisture imparting amount D is the moisture amount imparted to the image area. The moisture imparting amount D is expressed by an expression (1) using the moisture imparting amounts A, B and C and a coefficient E to the moisture imparting amount.

D=(A+B+C)*E expression (1)

When the printing mode is the one-sided printing mode, the moisture imparting amount D is the moisture amount imparted to the image area of the print surface. When the printing mode is the two-sided printing mode, the moisture imparting amount D is the moisture amount imparted to the image area of the first-printed surface (front surface). When the printing mode is the two-sided printing mode, the moisture imparting amount is smaller than the moisture imparting amount in the case of the one-sided printing mode. The CPU 201 checks whether the printing mode is the one-sided printing mode or the two-sided printing mode, and determines the value of the coefficient E according to the printing mode.

At ACT 25, the CPU 201 obtains a moisture imparting amount D′ by a total determination process 2. The moisture imparting amount D′ is the moisture amount imparted to the image area. The moisture imparting amount D′ is expressed by an expression (2) using the moisture imparting amounts A, B and C and coefficients E and F corresponding to the moisture amount.

D′=(A+B+C)*E*F expression (2)

When the printing mode is the two-sided printing mode, the moisture imparting amount D′ is the moisture imparting amount imparted to the image area of the second-printed surface (back surface). The coefficient F is a value smaller than 1. Accordingly, in the case of the two-sided printing mode, the moisture imparting amount D′ imparted to the image area of the back surface is smaller than the moisture imparting amount D imparted to the image area of the front surface.

At ACT 26, the CPU 201 obtains a moisture imparting amount H imparted to an area other than the image area by using the moisture imparting amount D and a set value G and by expression (3).

H=D+G expression (3)

In the case of the two-sided printing mode, a moisture imparting amount H′ imparted to an area other than the image area of the back surface is expressed by using the moisture imparting amount D′ and the set value G and by expression (4).

H′=D′+G expression (4)

After the moisture imparting amount is obtained by the above procedure, the process of ACT 03 of FIG. 3 is ended.

At ACT 04 of FIG. 3, the CPU 201 conveys the medium taken out from the medium holding part 40 to the medium conveyance part 20. At ACT 05, the CPU 201 outputs the moisture imparting amount obtained at ACT 03 to the moisture imparting part 60. The moisture imparting part 60 uses the inkjet head and imparts the solution to the print area of the medium based on the moisture imparting amount D. The moisture imparting part 60 uses the inkjet head and imparts the solution to the area other than the print area of the medium based on the moisture imparting amount H.

At ACT 06, the medium passing through the moisture imparting part 60 is fed to the medium conveyance part 20, and is sent to a portion under the inkjet head mount part 30, and an image is printed. At ACT 07, the CPU 201 determines whether printing is performed on both surfaces of the medium.

When printing is not performed on both the surfaces (ACT 07 NO), at ACT 08, it is checked whether the mode is the one-sided printing mode. In the case of the two-sided printing mode (ACT 08 NO), at ACT 11, the medium reversing part 50 executes the reversing operation of the medium. The CPU 201 conveys the reversed medium to the moisture imparting part 60. At ACT 05, the CPU 201 outputs the moisture imparting amount of the back surface obtained at ACT 03 to the moisture imparting part 60. The moisture imparting part 60 uses the inkjet head and imparts the solution to the print area of the medium based on the moisture imparting amount D′. The moisture imparting part 60 uses the inkjet head and imparts the solution to the area other than the print area of the medium based on the moisture imparting amount H′.

At ACT 06, the medium passing through the moisture imparting part 60 is fed to the medium conveyance part 20, and is sent to a portion under the inkjet head mount part 30, and an image is printed on the back surface.

When printing is performed on both the surfaces of the medium (ACT 07 YES), or when printing of one surface is performed in the one-sided printing mode (ACT 08 YES), the CPU 201 discharges the medium to the outside of the image forming apparatus. At ACT 09, the medium conveyance operation and the printing operation are stopped, and printing is ended at ACT 10.

Next, the effect of reduction of cockling and curl when the solution is imparted will be described.

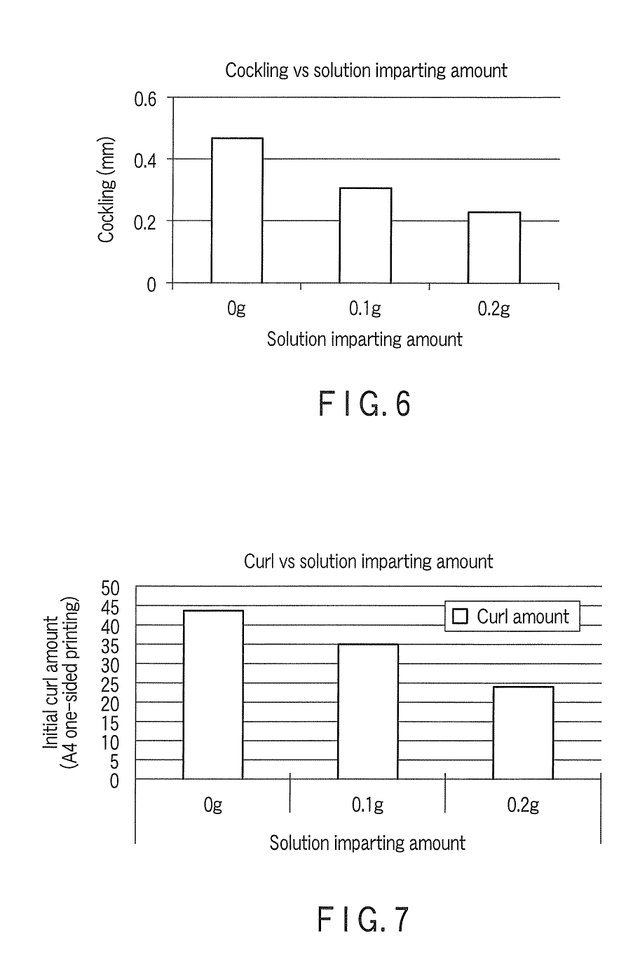

FIG. 6 is an exemplary view for explaining the effect of reduction of cockling when moisture is imparted in the inkjet image forming apparatus 1 of the embodiment. The horizontal axis of FIG. 6 indicates the solution imparting amount, and the vertical axis indicates the generated cockling amount. Here, the solution imparting amount is the solution amount imparted once per medium (A4: standard paper 5 g/one sheet).

An apparatus used in this test includes a medium conveyance mechanism to convey a medium and an inkjet head mechanism to form an image. The following three kinds of media are used in the test: (i) a medium to which the solution is not imparted, (ii) a medium to which the solution of 0.1 g is imparted, and (iii) a medium to which the solution of 0.2 g is imparted. The three kinds of media are respectively fed, images are formed, and the cockling is measured by a laser displacement meter immediately after the printing. Several peaks of measured waveforms are picked up from the apex, and average values of those are compared.

From the test result shown in FIG. 6, since the cockling is (iii)<(ii)<(i), it is understood that the effect of reduction of the cockling is obtained by increasing the imparted moisture.

FIG. 7 is an exemplary view for explaining the effect of reduction of curl when the moisture is imparted in the inkjet image forming apparatus 1 of the embodiment. The horizontal axis of FIG. 7 indicates the solution imparting amount, and the vertical axis indicates the generated curl amount. Since the method of the test is the same as that of the cockling, the detailed explanation is omitted.

From the test result shown in FIG. 7, since the curl is (iii)<(ii)<(i), it is understood that the effect of reduction of the curl is obtained by increasing the imparted moisture.

Next, the reason why the cockling and curl can be reduced by imparting the solution will be described.

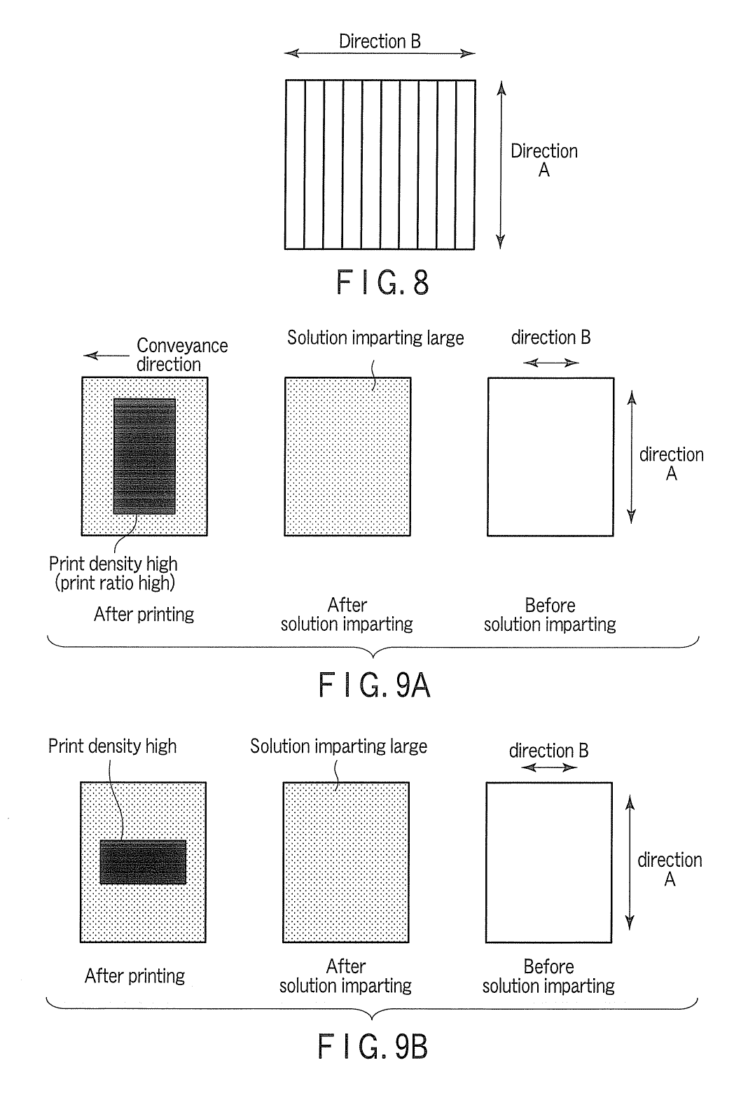

FIG. 8 is an exemplary view showing the direction of a fiber when the medium used in the inkjet image forming apparatus 1 of the embodiment is a paper.

It is assumed that the direction of the fiber is a direction A shown in FIG. 8. When an image is printed on the paper as the medium, the fiber of the paper expands due to the moisture included in ink and becomes thick. That is, the fiber becomes thick in a direction B shown in FIG. 8. On the other hand, in a non-printed part, the fiber does not expand and remain as it is. Thus, the paper as the medium includes an area where the fiber expands due to the moisture and an area where the fiber does not expand. As a result, it is conceivable that the cockling and curl occur. Accordingly, it is understood that when the solution is imparted so that the difference in moisture amount between the non-printed part and the printed part becomes small, the cockling and curl can be decreased.

Next, various modes of imparting the solution to the medium by using the inkjet image forming apparatus 1 will be described. These modes are modified examples of the embodiment.

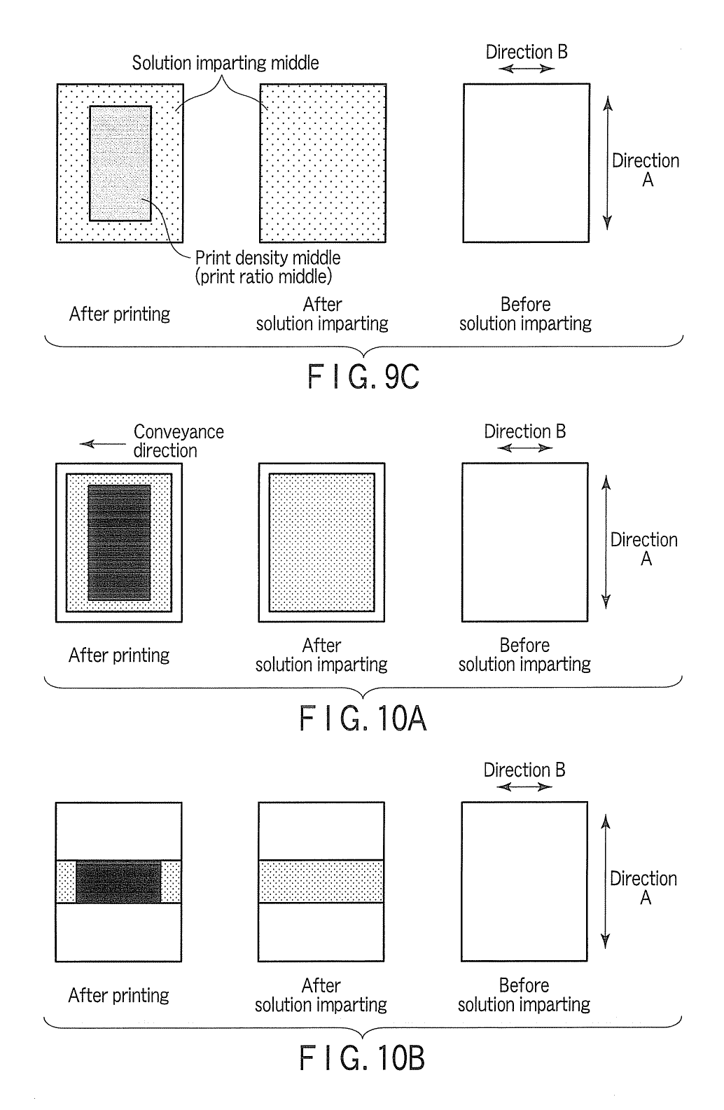

FIGS. 9A, 9B and 9C are exemplary views showing a first mode of imparting the solution by the image forming apparatus 1 of the embodiment. FIGS. 9A, 9B and 9C respectively schematically show three states of before solution imparting, after solution imparting, and after printing. In the first mode, the solution is uniformly imparted to the whole medium irrespective of whether the area is a print area or not. Incidentally, in the following, the print area is expressed as a rectangular area circumscribing an actual print area.

FIG. 9A shows a case where the print density (print ratio) in the print area is high. Thus, in the determination process of the moisture imparting amount, it is determined that the imparting amount is large. The solution is uniformly imparted to the whole medium.

As compared with FIG. 9A, in FIG. 9B, the print area has a shape thin and long in the direction B. Since the print density (print ratio) in the print area is high, in the determination process of the moisture imparting amount, it is determined that the imparting amount is large. The solution is uniformly imparted to the whole medium.

In FIG. 9C, the print area has the same shape as FIG. 9A. However, since the print density (print ratio) in the print area is middle, in the determination process of the moisture imparting amount, it is determined that the imparting amount is middle. The solution is uniformly imparted to the whole medium.

As the amount of printed ink become large, that is, as the print ratio of the image becomes high, the cockling and curl become large. Thus, as shown in FIG. 9A to 9C, a large amount of solution is imparted to the image having the high print ratio, and a small amount of solution is imparted to the image having the low print ratio, so that the cockling and curl can be reduced.

FIGS. 10A and 10B are exemplary views showing a second mode of imparting a solution by the image forming apparatus 1 of the embodiment. FIGS. 10A and 10B respectively schematically show three states of before solution imparting, after solution imparting, and after printing. In the second mode, although the solution is imparted to a part of a medium, the solution is uniformly imparted irrespective of whether the area is the print area or not.

In FIG. 10A, the solution is not imparted to the whole medium, but the solution is imparted to an area including the print area.

In FIG. 10B, the solution is imparted to the medium from end to end in the direction B. In the direction A, the solution is imparted to an area having the same width as the print width.

Since the direction in which the fiber expands is the direction B, as shown in FIG. 10B, the solution is imparted to the non-print area adjacent to the print area in the direction B so that the difference in moisture amount becomes small. Incidentally, the solution is imparted to the print area in the direction A. As stated above, in the second mode, the range in which the solution is imparted is changed correspondingly to the position of the image to be printed.

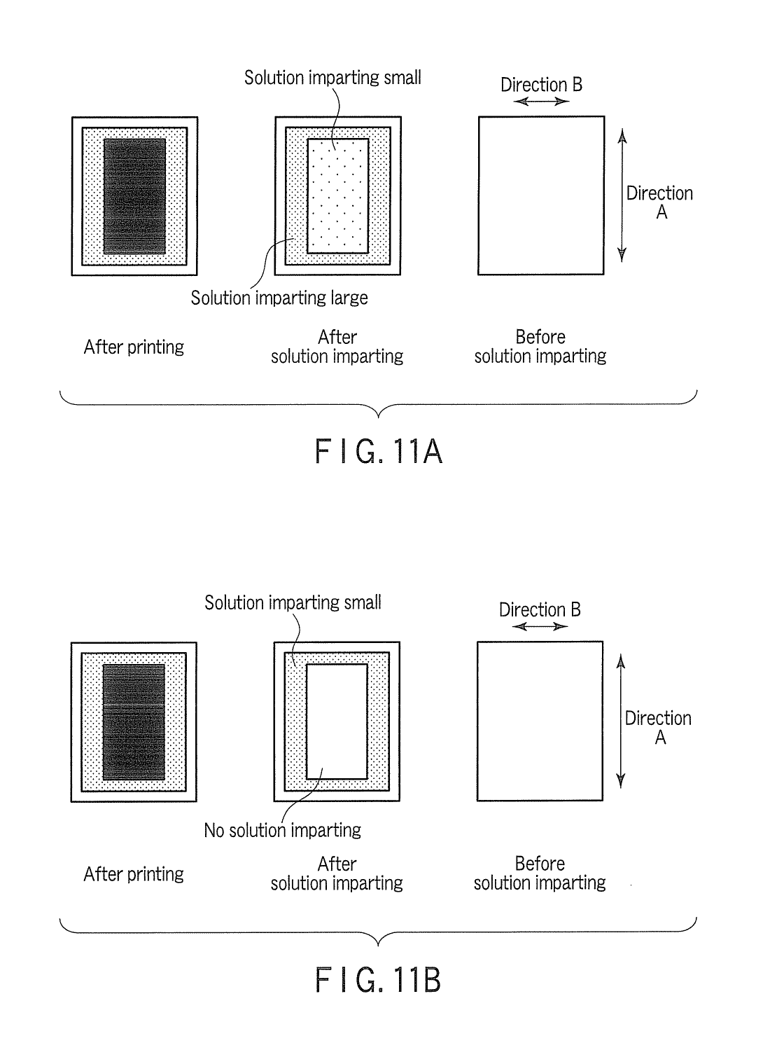

FIGS. 11A and 11B are exemplary views showing a third mode of imparting a solution by the image forming apparatus 1 of the embodiment. FIGS. 11A and 11B respectively schematically show three states of before solution imparting, after solution imparting, and after printing. In the third mode, the imparting amount of the solution is changed according to whether the area is the print area or not. Besides, the solution is imparted to a part of the medium.

In FIG. 11A, the print density (print ratio) in the print area is high. Thus, in the determination process of the moisture imparting amount, it is determined that the moisture imparting amount is large. The solution of the moisture imparting amount is imparted to the outside area of the image area. On the other hand, the solution of an amount smaller than the moisture imparting amount is imparted to the image area.

In FIG. 11B, the print density (print ratio) in the print area is high. Thus, in the determination process of the moisture imparting amount, it is determined that the moisture imparting amount is large. The solution of the moisture amount is imparted to an area surrounding the image area. On the other hand, the solution is not imparted to the image area.

In the image area, the fiber expands by the moisture included in ink. Thus, when the solution is imparted to the image area, the moisture is further increased. Thus, as shown in FIGS. 11A and 11B, for the portion corresponding to the image area, the imparted solution is decreased or the solution is not imparted.

As described above, in the embodiment, since the solution is imparted to the medium by using the inkjet head, the amount and the range of the imparted solution can be arbitrarily changed. Incidentally, the area to which the solution is imparted is not limited to the rectangular area. The solution can be imparted in accordance with an actually printed area.

Next, a method of determining whether the solution is to be imparted to the medium or not will be described. It is known that deformation (curl, cockling) of the medium becomes large in proportion to the moisture amount of ink, and the deformation amount is changed according to the moisture content of the medium. For example, a medium having a high moisture content has a small deformation amount, and a medium having a low moisture content has a large deformation amount.

In the embodiment, the solution is imparted to the medium under the following conditions.

(1) When the use environment of the apparatus or the paper feed cassette environment has a humidity of 70% or less, the solution is imparted. When the humidity exceeds 70%, the deformation amount is small, and it is not necessary to impart the solution.

(2) When ink having a large amount of moisture (moisture of 20% or more) is used, the solution is imparted. The imparting amount depends on experimental results.

(3) When an area of high-density solid printing (50% or more) exists and the area thereof is 100 mm² or more, the solution is imparted.

(4) When high-density solid printing (50% or more) is performed for 50% or more of the total area of the medium, the solution is imparted.

(5) When two-sided printing is performed, the solution is imparted.

(6) When the basis weight of a paper is 110 g/m² or less, the solution is imparted.

The moisture imparting amount may be changed stepwise according to the conditions (1) to (6). Besides, the amount may be changed according to one condition or a combination of some conditions of the above conditions (1) to (6).

Besides, when two-sided printing is performed, timing when the solution is imparted can be changed by selecting from the following A to C and according to the conditions (1) to (6).

A. surface before printing of a first surface+surface before printing of a second surface

B. only a surface before printing of the first surface

C. only a surface before printing of the second surface

When the solution is imparted to the medium in accordance with the structure and the control described above, the paper deformation (cockling, curl) caused when printing is performed with water-based ink can be reduced.

Incidentally, the respective functions described in the embodiment may be constructed by using hardware, or may be realized by using software and causing a computer to read a program describing the functions. Besides, the respective functions may be constructed by appropriately selecting any of the software and hardware.

Further, the respective functions can be realized by causing a computer to read a program stored in a not-shown recording medium. Here, in the recording medium of the embodiment, any recording form may be used as long as the recording medium can record the program and can be read by the computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet image forming apparatus comprising:
an inkjet head configured to discharge water-based ink and form an image on a surface of a recording medium;
a medium conveyance part configured to convey the recording medium;
a solution imparting part that is disposed upstream of the inkjet head in a recording medium conveyance direction and uses another inkjet head to impart a solution to the surface of the recording medium on which the image is formed; and
a controller configured to calculate an imparting amount of the solution to be imparted to the recording medium and control an imparting operation to the recording medium.

2. The apparatus of claim 1, wherein the solution is one of water and a processing liquid to which a wetting agent or a surfactant is added.

3. The apparatus of claim 1, wherein the controller calculates the imparting amount of the solution based on a combination of at least two of following conditions:
(1) a moisture amount of the ink used in printing,
(2) a density of the image to be printed,
(3) an area of an area of the image to be printed,
(4) a humidity of a machine use environment,
(5) a thickness of the recording medium, and
(6) a two-sided printing mode or a one-sided printing mode.

4. The apparatus of claim 3, wherein the controller controls the solution imparting part to impart the solution to the whole print surface of the recording medium.

5. The apparatus of claim 4, wherein the controller increases the calculated imparting amount of the solution correspondingly to a density increase of the image to be formed.

6. The apparatus of claim 3, wherein the controller controls the solution imparting part to impart the solution to an area of the recording medium including the image to be formed.

7. The apparatus of claim 3, wherein the controller calculates the imparting amount of the solution imparted to an area of the recording medium where the image is not formed to be larger than the imparting amount of the solution imparted to an area where the image is formed.

8. The apparatus of claim 3, wherein the controller calculates the imparting amount of the solution imparted in first printing in the two-sided printing mode to be smaller than the imparting amount of the solution imparted in printing in the one-sided printing mode.

9. The apparatus of claim 8, wherein the controller calculates the imparting amount of the solution imparted in second printing in the two-sided printing mode to be smaller than the imparting amount of the solution imparted in the first printing in the two-sided printing mode.

10. An image forming method of an inkjet image forming apparatus including an inkjet head configured to discharge water-based ink and form an image on a surface of a recording medium, and a solution imparting part configured to impart a solution to the surface of the recording medium on which the image is formed, comprising:
calculating an imparting amount of the solution to be imparted to the recording medium; and
controlling an imparting operation of the solution to the recording medium by using another inkjet head.

11. The method of claim 10, wherein the solution is one of water and a processing liquid to which a wetting agent or a surfactant is added.

12. The method of claim 10, wherein the calculating the imparting amount comprises calculating the imparting amount of the solution based on a combination of at least two of following conditions:
(1) a moisture amount of the ink used in printing,
(2) a density of the image to be printed,
(3) an area of an area of the image to be printed,
(4) a humidity of a machine use environment,
(5) a thickness of the recording medium, and
(6) a two-sided printing mode or a one-sided printing mode.

13. The method of claim 12, wherein the controlling the imparting operation comprises imparting the solution to the whole print surface of the recording medium.

14. The method of claim 13, wherein the calculating the imparting amount comprises increasing the calculated imparting amount of the solution correspondingly to a density increase of the image to be formed.

15. The method of claim 12, wherein the controlling the imparting operation comprises imparting the solution to an area of the recording medium including the image to be formed.

16. The method of claim 12, wherein the calculating the imparting amount comprises calculating the imparting amount of the solution imparted to an area of the medium where the image is not formed, to be larger than the imparting amount of the solution imparted to an area where the image is formed.

17. The method of claim 12, wherein the calculating the imparting amount comprises calculating the imparting amount of the solution imparted in first printing in the two-sided printing mode, to be smaller than the imparting amount of the solution imparted in printing in the one-sided printing mode.

18. The method of claim 17, wherein the calculating the imparting amount comprises calculating the imparting amount of the solution imparted in second printing in the two-sided printing mode, to be smaller than the imparting amount of the solution imparted in the first printing in the two-sided printing mode.
